(19) United States
(12) Patent Application Publication
(10) Pub. No.: US 2007/0045166 A1
(43) Pub. Date: Mar. 1, 2007

(54) Compliant connector for ECCS strainer modules

(75) Inventors: Alan Wayne Fanning, San Jose, CA (US); James Hibbert Oates, Gilroy, CA (US)

Correspondence Address: NIXON & VANDERHYE, PC, 901 NORTH GLEBE ROAD, 11TH FLOOR, ARLINGTON, VA, 22203, US

(73) Assignee: General Electric Company, Schenectady, NY (US)

(21) Appl. No.: 11/211,613

(22) Filed: Aug. 26, 2005

(51) Int. Cl. B01D 33/00

(52) U.S. Cl. 210/330; 210/488; 376/207; 285/18

(57) ABSTRACT

A compliant connector includes a coupling between adjacent strainer modules which accommodates differential thermal expansion and misalignment while precluding the creation of interface loads between the modules. The connector includes a coupling that makes internal or external connections with the inlet/outlet of the adjacent strainer modules. The coupling is configured at each end to accept a compliant seal comprised of a garter spring.

The present invention relates to a compliant connector for connecting adjoining strainer modules and particularly a compliant connector for suction strainer modules used in an emergency core cooling system (ECCS) in a nuclear power reactor system to accommodate differential thermal expansion and misalignment between adjacent strainer modules while precluding the creation of interface loads between the modules.

### BACKGROUND OF THE INVENTION

Emergency core cooling systems in a nuclear power plant, for example a pressurized water reactor (PWR) typically utilizes suction strainer modules to filter debris laden water that has drained from a reactor vessel in the event of a loss of coolant accident (LOCA). A loss of coolant accident may include a very highly energetic blow out of steam, water, gas and the like which creates one or more high pressured jets. These jets impact on adjacent areas e.g., piping insulation, known as a “zone of influence”. The debris generated by the loss of coolant accident typically may wash down to a lower level in the reactor containment basement where the water collects. Because the water in the containment vessel is recirculated through the reactor system, the debris laden water e.g., insulation, labels, paint debris, etc. must be filtered before the water is recirculated to the reactor system. Thus, one or more strainer modules are typically located in the water collection area in the containment basement to filter from the water particles in excess of a predetermined dimension e.g., particles in excess of, say, 0.1 inches.

The one or more strainer modules typically comprise multiple filtering disks in each module. Each disk includes a pair of spaced perforated plates with ribs therebetween defining flow passages directing the filtered water generally radially inward, e.g., a central flow path through the module. The filtered water is passed from the modules to a suction inlet in a sump area for return to the reactor system. Typically a series of modules are deployed and use bolted flanged piping connectors to interconnect the modules. Such connectors assure a continuous leak-type flow path from one module to the next. However this type of connection is not ideal. For example, the pipe flanges in the sizes of interest, on the order of 12-24 inches, tend to be quite heavy, which complicates installation and adds substantial costs when fabricated to nuclear grade standards. The rigidity of the bolted flange connections require that the associated modules be perfectly aligned to one another in order to obtain the required metal to metal contact and sealing at the flange faces. Due to the size and rigidity of the modules and manufacturing tolerances, this is not easily achieved in a given application. Further, due to the rigidity of the bolted flange connections in the modules themselves, there is little flexibility along the strainer module axis to accommodate differential thermal expansion and/or misalignment between adjacent strainer modules. Thermal and/or installation stresses are thus induced in the associated hardware complicating the design of the modules, anchors and/or supports.

In addition to piping flange connections noted above, flexible hose sections fabricated from braided wire mesh or bellows configurations have been used in comparable applications. However, those hose segments still use bolted flange connections between the adjacent strainer modules and, although they can accommodate differential expansion and misalignment due to the flexibility of the segment connecting the adjacent flanges, they cannot make the connection without inducing interface loads; interface loads due to bending, lateral offset and/or torsional misalignment displacements incurred on installation and/or during operation. Accordingly there is a need to provide a compliant connector for interconnecting strainer modules which accommodates different thermal expansion and misalignment between the modules while precluding the creation of interface loads between the modules.

In a preferred embodiment of the present invention there is provided a compliant connection connecting a pair of adjacent flow modules each including piping, a first module having a piping outlet and a second module having a piping inlet spaced from the piping outlet; a coupler disposed between the piping outlet and the piping inlet for enabling flow of a fluid from the first module to the second module, the coupler including an inlet adjacent the first module piping outlet and an outlet adjacent the second module piping inlet; a first garter spring interposed between the first module piping outlet and the coupler inlet, a second garter spring interposed between the second module piping inlet and the coupler outlet; the springs precluding passage of particles in excess of a predetermined size into the second module piping without forming a fluid tight seal between the coupler and the modules respectively.

In a further preferred aspect of the present invention there is provided an emergency core cooling system for a nuclear reactor, comprising a pair of adjacent flow strainer modules each including a central flow path and a plurality of disks for filtering debris from fluid surrounding the modules and directing the filtered fluid into the central flow area of the modules, a first module of the pair thereof having a piping outlet and a second module of the pair thereof having a piping inlet spaced from the piping outlet; a compliant connection between the pair of modules including a coupler disposed between the piping outlet and the piping inlet for enabling flow of the filtered fluid from the first module to the second module, the coupler including an inlet adjacent the first module piping outlet and an outlet adjacent the second module piping inlet; a first garter spring interposed between the first module piping outlet and the coupler inlet, a second garter spring interposed between the second module piping inlet and the coupler outlet; the springs precluding passage of particles in excess of a predetermined size into the second module without forming a fluid tight seal between the coupler and the modules respectively.

### DESCRIPTION OF THE DRAWINGS

FIG. 1 is a perspective view of a pair of suction strainer modules for use in an emergency core cooling system in a nuclear power reactor system in accordance with the prior art;

FIG. 2 is an exploded perspective view illustrating one of a plurality of perforated disks carried by each of the modules for filtering the water;

FIG. 3 is a cross-sectional view illustrating the prior art interconnection using heavy duty flanges between adjacent modules;

FIG. 4 is a view similar to FIG. 3 illustrating a compliant connector for the strainer modules according to a preferred embodiment of the present invention; and

FIGS. 5-8 are views similar to FIG. 4 illustrating further embodiments of a compliant connector hereof.

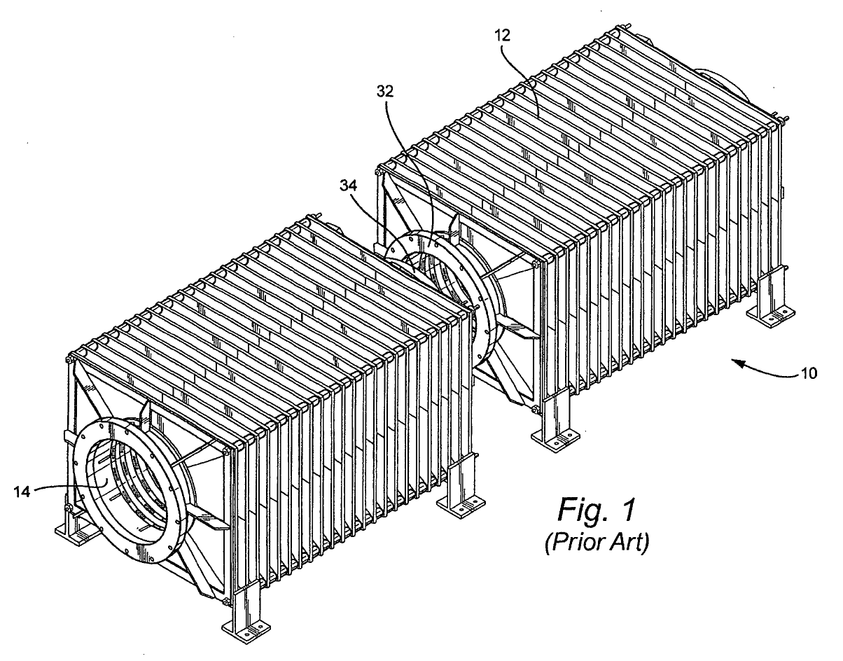

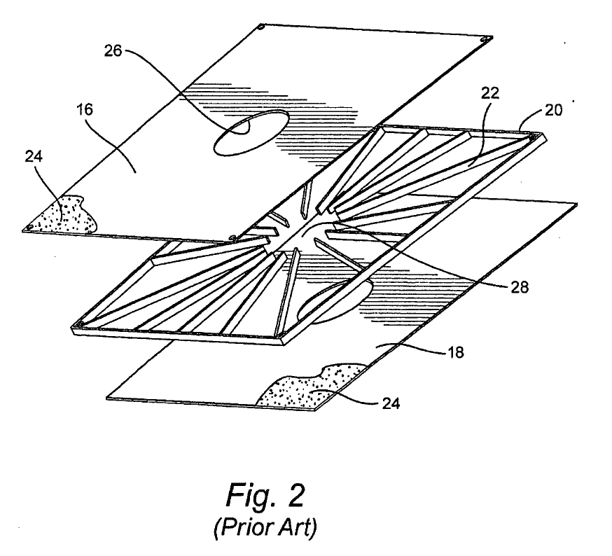

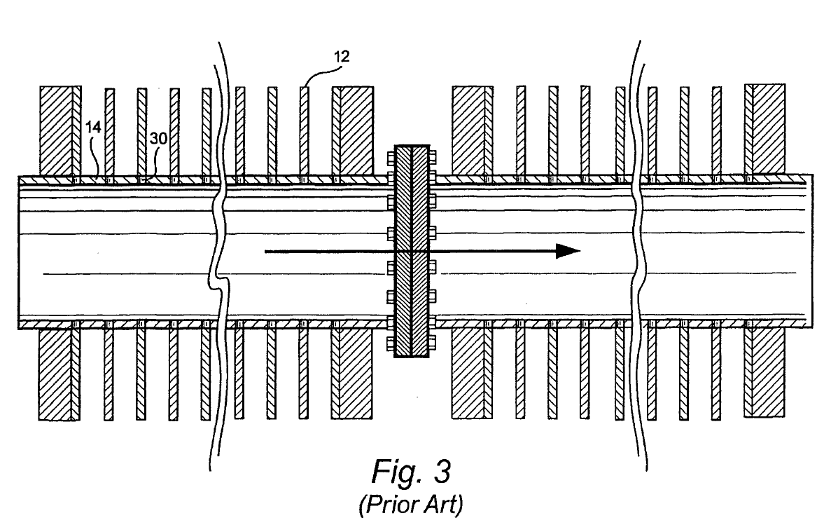

Referring now to the drawing figures, particularly to FIG. 1, there is illustrated a pair of suction strainer or flow modules generally designated 10. Each module includes a plurality of spaced disks secured to and extending about a central internal axially extending flow path 14. Each of the disks 12 includes a pair of plates 16 and 18 (FIG. 2) on opposite sides of a frame 20 comprised of a plurality of ribs 22 extending from the periphery of the frame 20 inwardly. Each of the plates 16 and 18 has a series of perforations 24 for filtering water into the area between the plates and the ribs 22 for flow into the central flow path 14. Each plate 16 and 18 includes a central opening 26 for receiving the central flow path 14 which also passes through the center opening 28 defined by the interior ends of the ribs 22. As illustrated in FIGS. 2 and 3, water passing through the perforations 24 of plates 16 and 18 is filtered and flows into the central flow path 14 by way of openings 30 (FIG. 3) in the wall of the central flow path 14. As previously explained, the modules 10 are located in a lower level of a nuclear reactor containment and in the event of a loss of coolant accident, water and debris would flow into the lower area surrounding the modules with the water being filtered by the perforated plates for flow into the central flow area 14 thence to a suction sump area, not shown. Thus only filtered water passes into the strainer module 14 for return to the reactor system.

As illustrated in FIGS. 1 and 3, central flow path 14 typically has large inlet and outlet flanges which facilitate bolting the central flow path 14 and the modules 10 to one another. As noted previously this type of connector between the adjacent modules is not ideal.

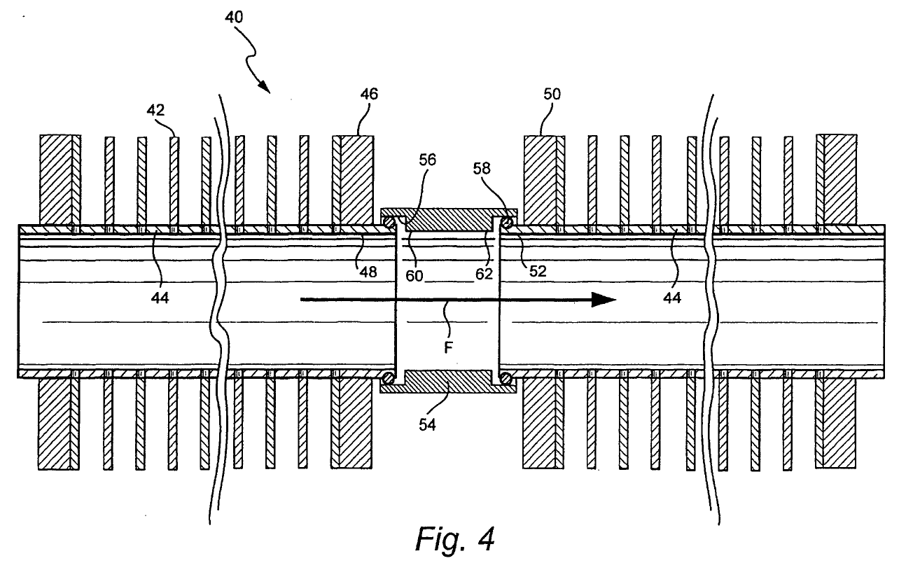

Referring now to FIG. 4, there is illustrated a pair of similar modules, generally designated 40, having disks 42, similar to disks 12, spaced one for the other about central flow path 44. The filtration aspect of the modules in FIG. 4 is similar to that aspect disclosed in FIGS. 1-3 with the exception of the connection between the adjacent modules. For clarity, the direction of flow is indicated by the arrow F and the modules are referenced as upstream and downstream modules respectively. It will be appreciated that more than two modules may be and are often utilized.

As illustrated in FIG. 4, the upstream or first module 46 terminates in a first module outlet 48 and the second or downstream module 50 has a inlet 52. It will be appreciated that the first module outlet 48 and the second module inlet 52 do not have radially extending flanges. To connect the upstream outlet and downstream inlet, a cylindrical coupler 54, includes a pair of annular recesses 56 at opposite ends. Garter springs 58 are disposed in the recesses 56 and thus are disposed between the first module outlet 48 and the coupler inlet 60 and between the second modular inlet 52 and the coupler outlet 62 respectively. The stepped or recessed interior diameter of the coupler 54 at opposite ends provides a constant flow area between the flow path 44 of adjoining modules 46 and 50. The garter springs 58 are helical extension or compression springs whose ends are connected to allow the springs 58 to be held in a circle. As noted previously, the garter springs form an effective debris seal for sealing out particles over a predetermined size from ingress into the interior of the flow path 44 although they do not provide leak tight seals for the water being circulated.

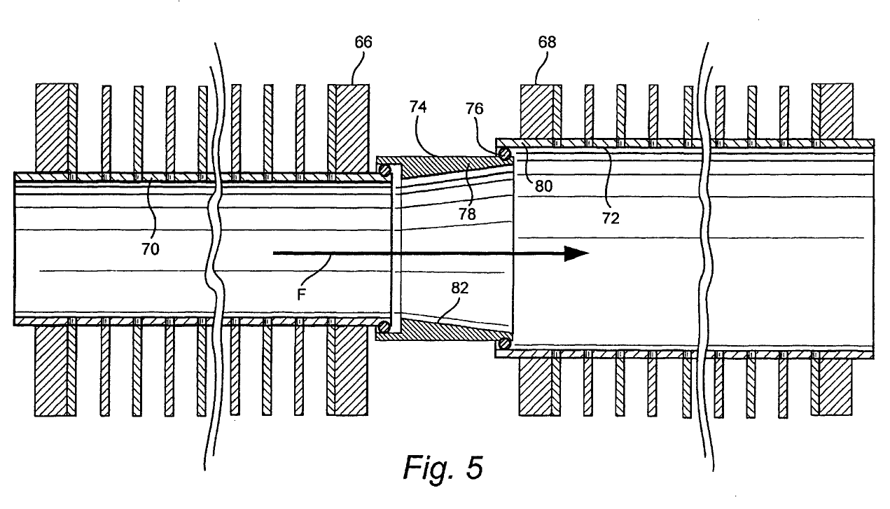

In FIG. 5, there is illustrated another embodiment of the invention wherein the upstream and downstream modules 66 and 68 respectively have central flow paths 70 and 72 of different diameters. As illustrated, the upstream outlet 70 is smaller in diameter than the downstream inlet 72. To accommodate the difference in diameters, the upstream end of the coupler 74 between modules 66 and 68 is the same as illustrated in FIG. 4. However, to accommodate the larger diameter inlet 72 of the downstream module 68, the garter spring 76 is mounted between the outside diameter of the downstream end 78 of the coupling 74 and the inner diameter of the downstream module inlet 80. Note also that the internal diameter of the coupler 74 tapers at 82 between its inlet to its outlet. This aspect enables successive modules in the flow path to have increasingly larger inside diameters. This enables the average axial flow velocity within each module to be more uniformly maintained even as the total volumetric flow rate through successive modules is increased as a result of water passing through the strainer disks and into the axial flow path at the center of the modules.

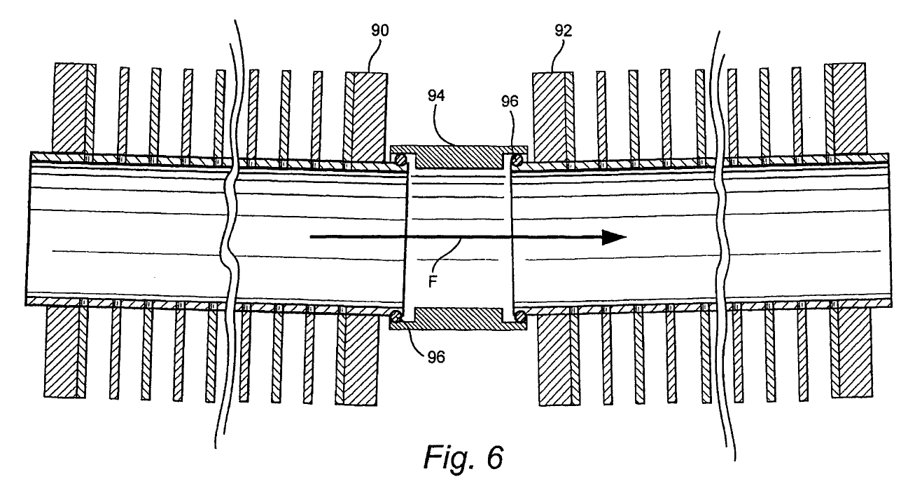

Referring now to FIG. 6, the upstream and downstream modules 90 and 92 are similar to the modules previously discussed. However, in this aspect as illustrated, the modules are angularly misaligned relative to one another. The garter springs 96 are disposed between the cylindrical coupler 94 and the inlet and outlet ends of the flow paths of the upstream and downstream modules are respectively similarly as illustrated in FIG. 4. Despite the misalignment of the modules, the compression/deformation of the garter springs 96 does not change significantly and interface loads are not developed by either thermal expansion or misalignment.

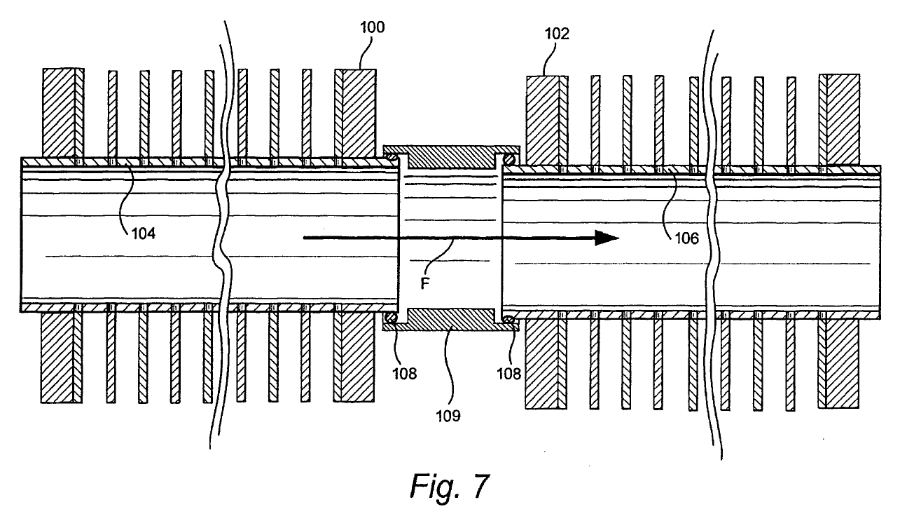

Referring to FIG. 7, upstream and downstream modules 100 and 102 respectively are similar to the modules previously described. In this aspect however, the upstream and downstream modules 100 and 102 are laterally offset while the axes of the central flow paths 104 and 106 remain parallel to one another. As illustrated, the compression/deformation of the garter springs 108 varies about the circumference of the springs. The coupling 109 is similar to the coupling illustrated in FIG. 6. The interface loads however remain modest due to a compliance inherent in the springs. It will be appreciated that the combination of the angular misalignment and lateral offset can be achieved by use of the garter springs.

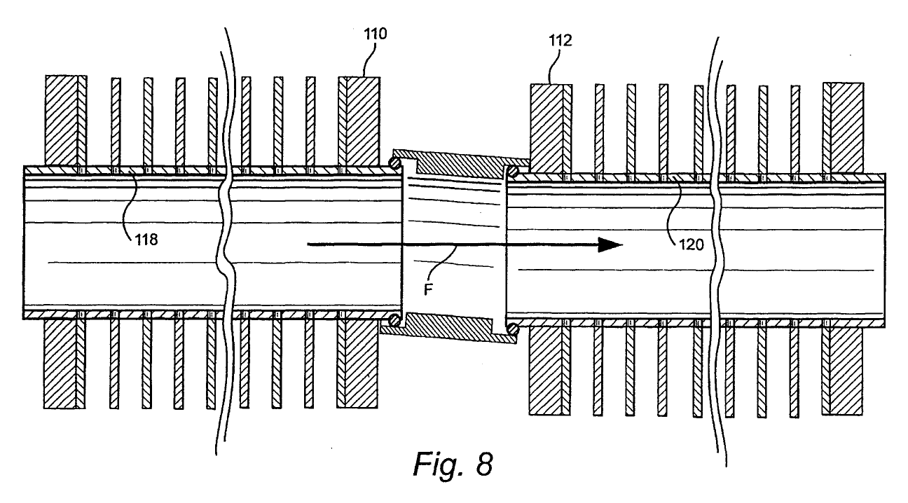

Referring now to FIG. 8, the upstream and downstream modules 110 and 112 respectively, similar to the previously described modules, are offset from one another and have parallel axes. In this aspect, the coupler 114 has an axis inclined to the axes of the central flow path 118 and 120 of the respective upstream and downstream modules. The compression/deformation of the garter spring seals 116 does not change significantly and interface loads are not developed by either thermal expansion or misalignment.

It will be appreciated that the various aspects of the invention set forth in FIGS. 4-8 entirely eliminate the pipe flanges previously utilized and the associated complications of installation and high cost of fabrication to nuclear grade standards. The requirement for accurate alignment between the central piping of the adjacent modules is also eliminated due to the compression/deformation of the garter springs. Moreover, the coupler in combination with the garter springs in the various aspects described enable the coupling to accommodate differential thermal expansion and/or misalignment between the adjacent modules.

Further, the compliance coupling of the present invention enables direct flow from module to module with minimum head loss, precludes passage of debris particles greater than a predetermined size through the connecting joint without requiring a water leak type seal at the joint, accommodates misalignment between adjacent strainer modules without inducing interface loads, accommodates differential thermal expansion between adjacent strainer modules without inducing interface loads and enables a transition and piping size from module to a module.

1-20. (canceled)

21. A compliant connection comprising:
a pair of adjacent flow modules each including a flowpath, a first module having an outlet and a second module having an inlet spaced from said outlet;
a coupler disposed between said outlet and said inlet for enabling flow of a fluid from the first module to the second module, said coupler including an inlet adjacent said first module outlet and an outlet adjacent said second module inlet;
a first garter spring interposed between said first module outlet and said coupler inlet,
a second garter spring interposed between said second module inlet and said coupler outlet;
said springs precluding passage of particles in excess of a predetermined size into the second module without forming a water tight seal between said coupler and said modules respectively.

22. A connection according to claim 21 wherein said coupler includes a recess along an interior diameter adjacent one of said coupler inlet and said coupler outlet, one of said first and second garter springs being disposed in said recess.

23. A connection according to claim 21 wherein said coupler includes recesses along interior diameters thereof adjacent said coupler inlet and said coupler outlet, respectively, said first and second garter springs being disposed in said respective recesses.

24. A connection according to claim 23 wherein said flowpaths are coaxial relative to one another.

25. A connection according to claim 21 wherein said coupler includes a recess along an interior diameter adjacent one of said coupler inlet and said coupler outlet, one of said first and second garter springs being disposed in said recess, another of said first and second garter springs being disposed about an exterior diameter of said coupler adjacent another of said coupler inlet and said coupler outlet.

26. A connection according to claim 25 wherein said coupler has an interior flow passage tapering from one module toward another of said modules.

27. A connection according to claim 21 wherein said coupler includes recesses along interior diameters thereof adjacent said coupler inlet and said coupler outlet, said first and second garter springs being disposed in said respective recesses, said flowpaths being angularly offset relative to one another.

28. A connection according to claim 21 wherein said coupler has an interior diameter corresponding to the interior diameter of each of said flowpaths.

29. A connection according to claim 21 wherein said coupler includes recesses along interior diameters thereof adjacent said coupler inlet and said coupler outlet, respectively, said first and second garter springs being disposed in said respective recesses, said flowpaths having axes radially offset relative to one another.

30. A connection according to claim 29 wherein said coupler has an axis parallel to the radially offset axes of said flowpaths.

31. A connection according to claim 9 wherein said coupler is cylindrical and has an axis angularly offset from the axes of said flowpaths.

32. An emergency core cooling system for a nuclear reactor, comprising:
a pair of adjacent flow strainer modules each including a central flowpath and a plurality of disks for filtering debris from fluid surrounding the modules and directing the filtered fluid into the central flowpath of the modules, a first module of said pair thereof having a flowpath outlet and a second module of said pair thereof having a flowpath inlet spaced from said flowpath outlet;
a compliant connection between said pair of modules including a coupler disposed between said flowpath outlet and said flowpath inlet for enabling flow of the filtered fluid from the first module to the second module, said coupler including an inlet adjacent said first module flowpath outlet and an outlet adjacent said second module flowpath inlet;
a first garter spring interposed between said first module flowpath outlet and said coupler inlet,
a second garter spring interposed between said second module flowpath inlet and said coupler outlet;
said springs precluding passage of particles in excess of a predetermined size into the second module flowpath without forming a fluid tight seal between said coupler and said modules respectively.

33. A system according to claim 12 wherein said coupler includes a recess along an interior diameter adjacent one of said coupler inlet and said coupler outlet, one of said first and second garter springs being disposed in said recess.

34. A system according to claim 32 wherein said coupler includes recesses along interior diameters thereof adjacent said coupler inlet and said coupler outlet, respectively, said first and second garter springs being disposed in said respective recesses.

35. A system according to claim 34 wherein said flowpaths are coaxial relative to one another.

36. A system according to claim 32 wherein said coupler includes a recess along an interior diameter adjacent one of said coupler inlet and said coupler outlet, one of said first and second garter springs being disposed in said recess, another of said first and second garter springs being disposed about an exterior diameter of said coupler adjacent another of said coupler inlet and said coupler outlet.

37. A system according to claim 32 wherein said coupler includes recesses along interior diameters thereof adjacent said coupler inlet and said coupler outlet, said first and second garter springs being disposed in said respective recesses, said flowpaths being angularly offset relative to one another.

38. A system according to claim 32 wherein said coupler includes recesses along interior diameters thereof adjacent said coupler inlet and said coupler outlet, respectively, said first and second garter springs being disposed in said respective recesses, said flowpaths having axes radially offset relative to one another.

39. A system according to claim 38 wherein said coupler has an axis parallel to the radially offset axes of said flowpaths.

40. A system according to claim 38 wherein said coupler is cylindrical and has an axis angularly offset from the axes of said flowpaths.
